(19) United States
(12) Patent Application Publication
(10) Pub. No.: US 2007/0227326 A1
(43) Pub. Date: Oct. 4, 2007

(54) Cutting apparatus for conduit

(76) Inventor: William R. Parnett, Walla Walla, WA (US)

Correspondence Address: LIEBLER, IVEY & CONNOR, P.S., 1141 N. EDISON, SUITE C, P O BOX 6125, KENNEWICK, WA, 99336, US

(21) Appl. No.: 11/397,511

(22) Filed: Apr. 4, 2006

(51) Int. Cl. B23D 45/06

(52) U.S. Cl. 83/477.2; 83/54

(57) ABSTRACT

The Cutting Apparatus for Conduit (100) disclosed and claimed herein securely clamps conduit with a clamping means comprised of a pressure shoe seat (8) forced against a conduit seat (9). The conduit seat (9) is urged away from a rotary saw blade (11) by a spring biasing means (18) comprised of at least one spring (18) being coil or leaf spring. When the clamping means is compressed the conduit seat (9) is depressed. A blade slot (12), in the conduit seat (9), allows conduit secured between the pressure shoe seat (8) and the conduit seat (9) to contact the rotary saw blade (11) when the conduit seat (9) is compressed. The conduit seat (9) secures the conduit at an acute blade angle (15) to the rotary saw blade (11). In the preferred embodiment the angular relationship of the conduit seat (9) to the rotary saw blade (11) allows a single cut to sever spirally wound conduit thereby allowing the conduit to be cut to a desired length and installed in the suitable electrical box or panel.

### FIELD OF THE INVENTION

This invention relates to an apparatus for cutting electrical conduit. The invention more specifically relates to an apparatus for cutting flexible spirally wound electrical conduit.

### BACKGROUND OF THE INVENTION

Devices for cutting conduit are known and are seen in the following patents: U.S. Pat. No. 3,093,023 to Vail; DES 266,736 and U.S. Pat. No. 4,336,652 to Robertson; DES 281,249 to Nall et al; U.S. Pat. No. 2,654,941 to Schleimer; U.S. Pat. No. 3,886,655 to Molnar; U.S. Pat. No. 4,142,290 and 4,769,909 to Ducret; U.S. Pat. No. 4,195,827 to Lyman; U.S. Pat. No. 4,291,453 to Mathieu; U.S. Pat. No. 4,364,292 to Wozniak et al; U.S. Pat. No. 4,901,438 to Gibney; U.S. Pat. No. 4,912,847 to Bradshaw; U.S. Pat. No. 5,070,615 to Michael III; U.S. Pat. No. 5,528,830 to Hansen; U.S. Pat. No. 5,671,646 to Sandford et al; and U.S. Pat. No. 5,806,188 to Caraballo.

The patents referred to herein are provided herewith in an Information Disclosure Statement in accordance with 37 CFR 1.97.

### SUMMARY OF THE INVENTION

Conduit cutting devices seen in prior inventions cut shielding along a longitudinal axis of the conduit. The Cutting Apparatus for Conduit (100) disclosed and claimed herein securely clamps conduit with a clamping means in a conduit seat. The conduit seat is urged away from a rotary saw blade by a spring biasing means. When the clamping means is compressed the conduit seat is depressed. A blade slot, in the conduit seat, allows the conduit to contact the rotary saw blade when the conduit seat is compressed. The conduit seat secures the conduit at an acute angle to the rotary saw blade. In the preferred embodiment the angular relationship of the conduit seat to the rotary saw blade allows a single cut to sever spirally wound conduit thereby allowing the conduit to be cut to a desired length and installed in the suitable electrical box or panel. The present invention is an improvement over the Tool for cutting Flexible Conduit of U.S. Pat. No. 3,093,023 to Vail.

### BRIEF DESCRIPTION OF THE DRAWINGS

The foregoing and other features and advantages of the present invention will become more readily appreciated as the same become better understood by reference to the following detailed description of the preferred embodiment of the invention when taken in conjunction with the accompanying drawings, wherein:

FIG. 1 is a side elevation of the Cutting Apparatus for Conduit (100) showing a motor and apparatus housing (1), a handle means (2) fixed to the housing, a clamp lever means (3) pivotally affixed to the handle means (2), the clamp lever means (3) pivotally connected to a conduit pressure shoe (7); a conduit seat (9), which is a part of a seat housing (10), is movably affixed in the seat housing (10) and is spring biased upwardly by spring means (18); power and motor means (4) received in the housing (1), which is in rotational communication with a shaft (13) and a rotary saw blade (11).

FIG. 2 illustrates an elevation cutaway or section A-A and B-B of FIG. 1 showing a conduit pressure shoe (7) and a pressure shoe seat (8), power and motor means (4) received in the housing (1), which is in rotational communication with a shaft (13). Also seen is a rotary blade (11) which contacts cable shielding via a blade slot (12) found in the conduit seat (9).

FIG. 3 is a bottom plan showing the sections A-A and B-B of FIG. 1 which reveals the relationship of the rotary blade (11) and shaft (13) to the conduit pressure shoe (7), the pressure shoe seat (8) and seat housing (10). Also seen is the angle (15) between the seat housing (10) and the rotary blade (11).

FIG. 4 is a top plan illustrating the relationship of the seat housing (10) to the motor and apparatus housing (1). Shown is the angular relationship of the seat housing (10) and motor and apparatus housing (1).

FIG. 5 is a top plan section D-D from FIG. 1 showing the conduit seat (9) and blade slot (12).

FIG. 6 is a isometric section E-E from FIG. 5 illustrating spring biasing means (18) from the seat housing (10) against the conduit seat (9). The spring biasing means (18) affixes the seat housing (10) to the conduit seat (9). The conduit seat (9) is urges upwardly and away from the rotary blade (11) by the spring biasing means (18) until compressed a action of the clamp lever means (3) pivotally urging the conduit pressure shoe (7) pressure shoe seat (8) downwardly thereby moving the conduit seat (9) downwardly allowing the rotary blade (11) to pass through the blade slot (12) and into contact with conduit.

FIG. 7 is a side elevation cutaway section F-F from FIG. 5 showing the seat housing (10), the conduit seat (9), the blade slot (12), springs (18), rotary blade (11), shaft (13), conduit seat retainer (19), gap (20), top of the conduit seat (21) and power and motor means (4).

### DETAILED DESCRIPTION

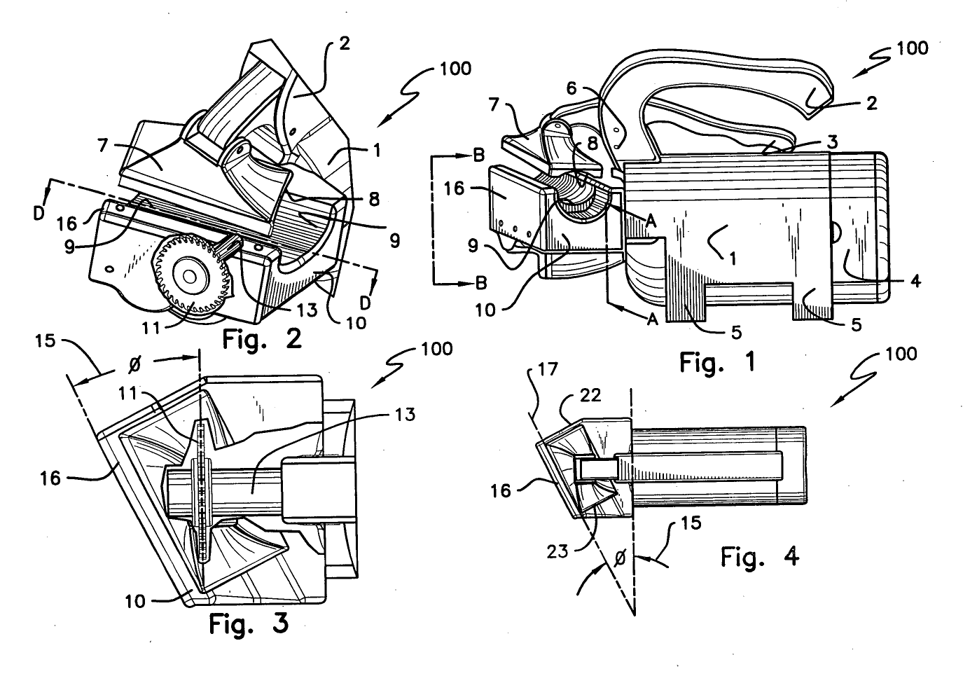

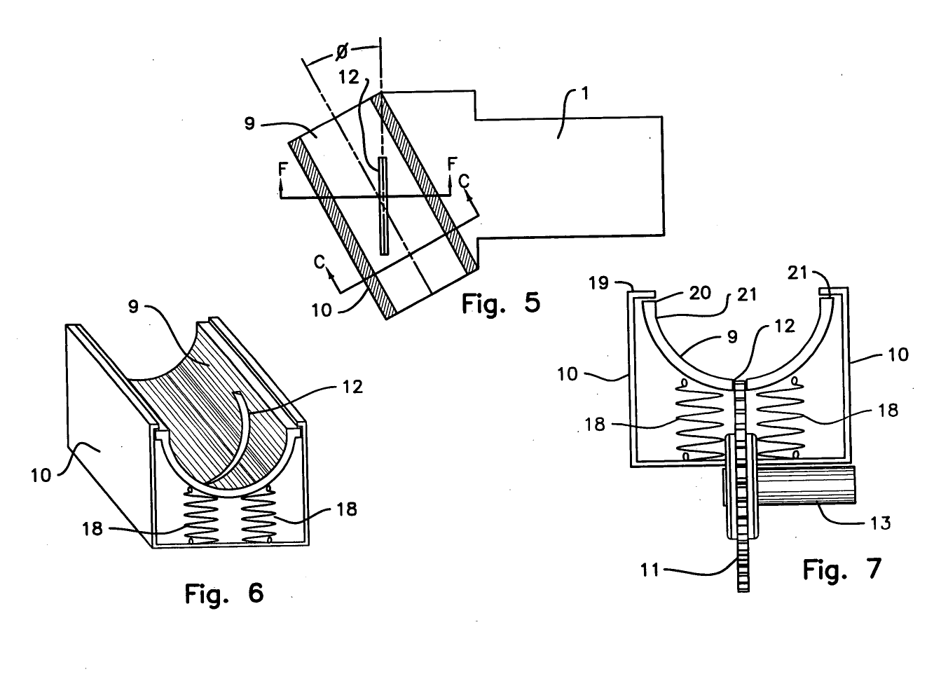

FIGS. 1, 2, 3 and 4 illustrate the Cutting Apparatus for Conduit. This disclosure is an improvement over U.S. Pat. No. 3,093,023 to Vail. FIG. 1, 2, 3, 4, 5 and 6 illustrate the Cutting Apparatus for Conduit (100). FIG. 1 shows the preferred embodiment comprising a motor and apparatus housing (1). A handle (2) is immovably fixed to the housing for gripping and controlling the apparatus. A lever means (3) comprising a clamp lever (3) is pivotally affixed to the handle means (2). The clamp lever (3) pivotally connected to a conduit pressure shoe (7) having a pressure shoe seat (8); a conduit seat (9) which is a part of a seat housing (10), power and motor means (4) received in the housing (1), which is in rotational communication with a shaft (13).

A motor and apparatus housing (1) has having a cutting end (16) and a handle means (2) immovably affixed to the housing proximal the cutting end (16). The handle means (2) comprises a handle (2) for control of the apparatus. A clamp lever means (3) is a clamp (3) comprised of an elongated lever which is pivotally affixed to the handle (2). Those of ordinary skill in the mechanical arts will appreciate that the clamp (3) may be affixed to other than the handle (2) in order to fulfill its compression function. The clamp (3) is proximal the cutting end (16). The clamp (3) is connected to a conduit pressure shoe (7) to exert downward force on the conduit pressure shoe (7). In the preferred embodiment the clamp (3) is pivotally connected to the conduit pressure shoe (7). The conduit pressure shoe (7) is distal from the handle (2) and has a downwardly facing pressure shoe seat (8). A seat housing (10) is at the cutting end (16) and has an upwardly facing conduit seat (9).

The conduit seat (9), in the preferred embodiment, is movably affixed in the seat housing (10) having spring biasing means (18) from the seat housing (10) against the conduit seat (9). Spring biasing means (18), in the preferred embodiment is coil or leaf springs (18) urging the conduit seat upwardly. The spring (18) can be affixed to the seat housing (10) and to the conduit seat (9) as a method of retaining the conduit seat (9) in the seat housing (10).

In the preferred embodiment the conduit seat (9) is urged upwardly and away from a rotary blade (11) by at least one spring (18). Conduit is received between the pressure shoe seat (8) and the compression of the clamp (3) pivotally urges the conduit pressure shoe (7) and pressure shoe seat (8) downwardly against the conduit thereby moving the conduit seat (9) downwardly against the at least one spring (18).

A blade slot (12), comprised of a slot sized to receive a rotary blade (11), is in the conduit seat (9) and allows the rotary blade (11) to pass through the blade slot (12) and into contact with the conduit.

Power and motor means (4) are, in the preferred embodiment, located in the housing (1) and include battery, direct connection via extension cords to electrical outlets, pneumatic or hydraulic power to provide rotation of a shaft (13) which rotates a rotary saw blade (11). Power and motor means (4) may also be provided by coupling the shaft (13) to a portable drill motor. In the preferred embodiment the power and motor means (4) is in the housing (1) and is distal to the cutting end (16). Said power and motor means (4) is in rotational communication with a shaft (13). The rotary blade (11) is affixed to the shaft (13) proximal the cutting end (16).

The seat housing (10) has an axis (17) centrally positioned from a seat housing first end (22) to a seat housing second end (23). The rotary blade (11) is planar. The angular relationship of the seat housing (10) and hence the conduit seat (9) and the pressure shoe seat (8) and the rotary blade (11) is an acute blade angle (15). The acute blade angle (15) is between the axis (17) and the rotary blade (11). In the preferred embodiment the acute angle is 22.5 degrees.

The clamp (3) is connected to the conduit pressure shoe (7) to exert downward force on the conduit pressure shoe (7). The conduit pressure shoe (7) is distal from the handle (2). The seat housing (10) is at the cutting end (16) having a conduit seat (9) proximal and below the conduit pressure shoe (7) and pressure shoe seat (8).

In an alternative embodiment the conduit seat (9) is movably received in the seat housing (10), is spring biased upwardly by at least one spring (18) from the seat housing (10) upwardly against the conduit seat (9) and is restrained in upper movement by the conduit seat (9) restraining means (19). As seen in FIG. 7, the restraining means (19) orthogonally extends from the seat housing (10) over the conduit seat (9) at a conduit seat top (21). When the conduit seat (19) is compressed a gap (20) exists between the conduit seat top (21) and the seat housing (10).

The conduit seat (9) is urged upwardly and away from a rotary blade (11) by the at least one spring (18). The conduit is received between the pressure shoe seat (8) and compression of the clamp lever means (3) pivotally urges the conduit pressure shoe (7) and pressure shoe seat (8) downwardly against the conduit thereby moving the conduit seat (9) downwardly against the at least one spring (18).

The blade slot (12) in the conduit seat (9) allows the rotary blade (11) to pass through the blade slot (12) and into contact with the conduit when the conduit seat (9) is urged downwardly against the at least one spring (18).

The seat housing (10) has an axis (17) centrally positioned from a seat housing first end (22) to a seat housing second end (23). The rotary blade (11) is planar and an acute blade angle (15) exists between the axis (17) and the planar rotary blade (11).

Spring biasing means (18) is comprised of coil or leaf springs. Those of ordinary skill in the spring arts will recognize that other means of spring biasing will be equivalent to coil or leaf springs including, for example, elastic materials.

In a simple statement, the invention is comprised of a conduit clamping means to receive and secure conduit; a conduit cutting means fixedly secured relative to the conduit clamping means; the conduit clamping means fixedly securing conduit at an acute angle to a cutting plane of the cutting means; positioning means to move the conduit clamping means proximal to the cutting means so that the cutting means will contact and cut conduit fixedly secured by the conduit clamping means. The conduit clamping means to receive and secure conduit comprised of a conduit pressure shoe (7) and a pressure shoe seat (8) and a conduit seat (9) proximal and below the conduit pressure shoe seat (8). The cutting means is comprised of a rotary blade (11). The positioning means comprised of a clamp (3) pivotally affixed to a housing (1) and pivotally affixed to the conduit pressure shoe (7) and urging downward force against the conduit pressure shoe (7) when the clamp (3) is moved upwardly. A seat housing (10) is below the conduit pressure shoe (7) and has a conduit seat (9) proximal and below the conduit pressure shoe (7) and conduit pressure shoe seat (8). A blade slot (12) in the conduit seat (9) allows the rotary blade (11) to pass through the blade slot (12) and into contact with the conduit when the conduit seat (9) is urged downwardly against the at least one spring (18). The conduit seat (9) is movably received in the seat housing (10). Spring biasing means (18) from the seat housing (10) upwardly against the conduit seat (9) urges the conduit seat upwardly. The conduit seat (9) is restrained in upper movement by conduit seat (9) restraining means. The conduit pressure shoe seat (8) and the conduit seat (9) are geometrically shaped to receive tubular conduit having a variety of cross sections; the geometrical cross section of the conduit pressure shoe seat (8) and conduit seat (9) are generally concave. Power and motor means (4) is in power and rotation communication with a shaft (13); the rotary blade (11) is affixed to the shaft (13) proximal the conduit seat (9); the angular relationship of the conduit seat (9), and hence conduit, with the rotary blade (11) is acute.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1. A Cutting Apparatus for Conduit (100) comprising:
a. a motor and apparatus housing (1) having a cutting end (16); a handle means (2) immovably affixed to the housing proximal the cutting end (16);
b. a clamping lever means (3) pivotally affixed to the handle means (2) proximal the cutting end (16); the clamp lever means (3) connected to a conduit pressure shoe (7) to exert downward force on the conduit pressure shoe (7); the conduit pressure shoe (7) is distal from the handle means (2); a seat housing (10) is at the cutting end (16) having a conduit seat (9);
c. the conduit seat (9) is movably affixed in the seat housing (10); spring biasing means (18); from the seat housing (10) against the conduit seat (9) urges the conduit seat upwardly; the spring biasing means (18) affixes the seat housing (10) to the conduit seat (9);
d. the conduit seat (9) is urged upwardly and away from a rotary blade (11) by the spring biasing means (18); conduit is received between the pressure shoe seat (8) and compression of the clamp lever means (3) pivotally urges the conduit pressure shoe (7) pressure shoe seat (8) downwardly against the conduit thereby moving the conduit seat (9) downwardly against the spring biasing means (18);
e. a blade slot (12) in the conduit seat (9) allows the rotary blade (11) to pass through the blade slot (12) and into contact with the conduit;
f. power and motor means (4) received into the housing (1) distal to the cutting end (16); said power and motor means (4) is in rotational communication with a shaft (13); the rotary blade (11) is affixed to the shaft (13) proximal the cutting end (16);
g. the seat housing (10) having an axis (17) centrally positioned from a seat housing a first end (18) to a seat housing second end (19); the rotary blade (11) is planar; an acute blade angle (15) between the axis (17) the rotary blade (11).

2. A Cutting Apparatus for Conduit (100) comprising;
a. a motor and apparatus housing (1) having a cutting end (16); a handle means (2) immovably affixed to the housing proximal the cutting end (16),
b. a clamp lever means (3) pivotally affixed to the handle means (2) or pivitally affixed to the motor and apparatus housing (1) proximal the cutting end (16); the clamp lever means (3) connected to a conduit pressure shoe (7) to exert downward force on the conduit pressure shoe (7); the conduit pressure shoe (7) is distal from the handle means (2); a seat housing (10) is at the cutting end (16) having a conduit seat (9) proximal and below the conduit pressure shoe (7);
c. the conduit seat (9) is movably affixed in the seat housing (10); spring biasing means (18) from the seat housing (10) against the conduit seat (9) urges the conduit seat upwardly; the conduit seat (9) is restrained in upper movement by the conduit seat (9) restraining means;
d.the conduit seat (9) is urged upwardly and away from a rotary blade (11) by the spring biasing means (18); conduit is received between the pressure shoe seat (8) and compression of the clamp lever means (3) pivotally urges the conduit pressure shoe (7) pressure shoe seat (8) downwardly against the conduit thereby moving the conduit seat (9) downwardly against the spring biasing means (18);
e. a blade slot (12) in the conduit seat (9) allows the rotary blade (11) to pass through the blade slot (12) and into contact with the conduit when the conduit seat (9) is urged downwardly against the spring biasing means (18);
f. power and motor means (4) received in the housing (1) distal to the cutting end (16); said power and motor means (4) is in rotational communication with a shaft (13); the rotary blade (11) is affixed to the shaft (13) proximal the cutting end (16);
g. the seat housing (10) having an axis (17) centrally positioned from a seat housing first end (22) to a seat housing second end (19); the rotary blade (11) is planar; an acute blade angle (15) between the axis (17) and the rotary blade (11).

3. A Cutting Apparatus for Conduit (100) from claim 2 further comprising:
a.spring biasing means (18) comprised of at least one spring (18).

4. A Cutting Apparatus for Conduit (100) from claim 3 further comprising:
a. conduit seat (9) restraining means comprised of spring biasing means (18) affixed to the seat housing (10) and to the conduit seat (9) or by a seat housing retainer (19) at a top of the conduit seat (21); a gap (20) between the top of the conduit seat (21) and the seat housing retainer (19) when the conduit pressure shoe (7) is pressed against the conduit and exerts downward forces against the conduit seat (9);
b. the at least one spring comprised of coil or leaf springs.

5. A Cutting Apparatus for Conduit (100) comprising:
a. a conduit clamping means to receive and secure conduit;
b. a conduit cutting means fixedly secured relative to the conduit clamping means;
c. the conduit clamping means fixedly securing conduit at an acute angle to a cutting plane of the cutting means;
d. positioning means to move the conduit clamping means proximal to the cutting means so that the cutting means will contact and cut conduit fixedly secured by the conduit clamping means.

6. A Cutting Apparatus for Conduit (100) from claim 5 further comprising:
a. conduit clamping means to receive and secure conduit comprised of a conduit pressure shoe (7) having a pressure shoe seat (8), a conduit seat (9) proximal and below the conduit pressure shoe seat (8);
b. cutting means comprised of a rotary blade (11);
c. positioning means comprised of a clamp lever means (3) pivotally affixed to a housing (1) and pivotally affixed to the conduit pressure shoe (7) and urging downward force against the conduit pressure shoe (7) when the clamp lever means (3) is moved upwardly; a seat housing (10) is below the conduit pressure shoe (7) and has a conduit seat (9) proximal and below the conduit pressure shoe (7);
d. a blade slot (12) in the conduit seat (9) allows the rotary blade (11) to pass through the blade slot (12) and into contact with the conduit when the conduit seat (9) is urged downwardly against a spring biasing means (18);
e. the acute blade angle (15) between the axis (17) and the planar rotary blade (11) is in the range of 0 degrees to 89 degrees.

7. A Cutting Apparatus for Conduit (100) from claim 6 further comprising:
a. the conduit seat (9) is movably received in the seat housing (10); spring biasing means (18) from the seat housing (10) upwardly against the conduit seat (9) urges the conduit seat upwardly; the conduit seat (9) is restrained in upper movement by conduit seat (9) restraining means;
b. the conduit pressure shoe (7) and the conduit seat (9) are geometrically shaped to receive tubular conduit having a variety of cross sections; the geometrical cross section of the conduit pressure shoe (7) and conduit seat (9) are generally concave;
c. power and motor means (4) is in power and rotation communication with a shaft (13); the rotary blade (11) is affixed to the shaft (13) proximal the conduit seat (9).
d. the acute blade angle (15) between the axis (17) and the planar rotary blade (11) is 22.5 degrees.

8. A Cutting Apparatus for Conduit (100) from claim 7 further comprising:
a. spring biasing means (18) comprised of at least one spring (18);
b. power and motor means (4) comprised of electrical, pneumatic or hydraulic motors.

9. A Cutting Apparatus for Conduit (100) from claim 8 further comprising:
a. the at least one spring (18) composed of coil or leaf spring;
b. electrical power and motor means (4) receiving power from battery, electrical sources external from the apparatus (100) or by coupling of a portable drill motor to the shaft (13).
